(19) United States
(12) Patent Application Publication
(10) Pub. No.: US 2026/0142483 A1
(43) Pub. Date: May 21, 2026

(54) CHARGING DEVICE WITH AN INTERFACE

(71) Applicant: Andreas Stihl AG & Co. KG, Waiblingen (DE)

(72) Inventor: Joachim Kolb, Weinstadt (DE)

(21) Appl. No.: 19/389,622

(22) Filed: Nov. 14, 2025

(30) Foreign Application Priority Data
Nov. 18, 2024 (DE) 10 2024 133 754.0

(51) Int. Cl. H02J 7/00; G06F 3/041

(52) U.S. Cl. CPC H02J 7/751; H02J 7/80; G06F 3/0416

(57) ABSTRACT

A charging device is for charging a battery pack. The charging device has a device housing, which has a first housing side and a second housing side. A first interface for operating the charging device is provided, as well as a charging terminal for connecting the battery pack to the charging device. The charging terminal and the first interface are arranged on the first housing side of the device housing. The charging device has a second interface for operating the charging device. The second interface is arranged on the second housing side of the device housing so that it can be used from the second housing side.

### CROSS-REFERENCE TO RELATED APPLICATIONS

This application claims priority of German patent application no. 102024133 754.0, filed November 18, 2024, the entire content of which is incorporated herein by reference.

### TECHNICAL FIELD

The disclosure relates to a charging device for charging a battery pack, having a device housing, which has a first housing side and at least one second housing side as well as a charging terminal for connecting the battery pack to the charging device. The charging terminal is configured to be connected electrically and/or mechanically to the battery pack in such a way that the battery pack can be charged by the charging device via the charging terminal. In addition, a first interface for the operation display and/or for operating the charging device is provided, the charging terminal and the first interface being arranged on the first housing side. They can be seen and/or operated from the first housing side.

### SUMMARY

It is an object of the disclosure to improve a charging device of the type mentioned above.

The charging device has a first interface for operating the charging device. The interface is configured for operating the charging device. For example, operating elements may be provided for starting the charging process, for selecting a charging process, or the like. Such an interface for operating the charging device is arranged on the housing side of the charging device on which the charging terminal for a battery pack to be charged is also provided.

The interface may additionally have at least some visual displays, which display for example the charging process, the state of charge of the attached battery pack, the readiness for charging and/or the charging process.

The charging device has a second interface for operating the charging device, the second interface being arranged on the second housing side. The second interface is visibly and/or manually accessible from the second housing side of the device housing. This improves the handling of the charging device for different operating positions.

The charging device may furthermore be adapted or used with the further interface to charge battery packs with a different size and/or capacity. Even if a battery pack with a large volume is connected to the charging terminal and, because of its size, the battery pack fully or partially covers the interface for the operation display and/or for operating the charging device on the side of the charging terminal, the user still has the opportunity to use a visibly and/or manually accessible interface straightforwardly for the operation display and/or for operating the charging device. For battery packs with a relatively small configuration size, this may be the first interface on the first housing side, or for a relatively large configuration size of the battery pack the second interface on the second housing side.

Advantageously, the first interface and the second interface are configured at least partially in the same way. In a particular embodiment of the disclosure, the first interface and the second interface are configured entirely in the same way. The same or an identical configuration of the first interface and the second interface allows a smaller number of different modules for constructing the charging device, such that each module can be installed both as the first interface and as the second interface.

The first interface and/or the second interface in one embodiment of the disclosure has a display unit. The latter is used straightforwardly as a visual display of the operating modes. In order to simplify the structure of the charging device, it may be advantageous to couple the display units of the interfaces optically to a light source arranged in the device housing. A further advantageous embodiment of the disclosure may consist in optically forwarding the visual display of a first display unit of a first interface via a light guide onto the visual display of a second display unit of a second interface. In this way, only one display unit needs to be electronically driven.

In a further embodiment of the disclosure, the first interface and/or the second interface is configured as an operating unit. For example, the strength of the charging current and/or the type of operation of the charging process may be selected and/or adjusted on the operating unit.

Preferably, the first interface and/or the second interface is configured as a combined display unit and operating unit. In an embodiment of the disclosure, the first interface and/or the second interface is configured as a display screen unit, in particular as a touchscreen. A display screen unit on the one hand enables a simple display of the operating modes and at the same time is suitable as an operating unit for the charging device. The display screen unit is compactly configured, occupies little space and can easily be installed manually.

The device housing of the charging device includes a front wall, a bottom wall and side walls that connect the front wall to the bottom wall. In one embodiment of the disclosure, the front wall lies on the first housing side. The bottom wall of the device housing lies on the second housing side. The charging device can therefore be plugged onto a battery pack and operated via the second interface from the side of the device housing that lies opposite the battery pack. This is advantageous particularly for battery packs with a large volume, or large format. It may also be advantageous for one of the side walls to be assigned to the second housing side of the device housing.

In an embodiment of the disclosure, the charging device may include at least one third interface for the operation display and/or for operating the charging device. The third interface is preferably arranged on a third housing side of the device housing. The third housing side is a side wall of the device housing. In this embodiment, the charging device may be monitored and/or operated easily in different operation settings.

### BRIEF DESCRIPTION OF DRAWINGS

The invention will now be described with reference to the drawings wherein:

FIG. 1 shows a perspective view of a charging device for charging a battery pack;

FIG. 2 shows a view of the bottom wall of the charging device according to FIG. 1; and,

FIG. 3 shows a schematic section through the charging device according to FIG. 1 with a battery pack attached to the charging terminal of the charging device.

### DETAILED DESCRIPTION

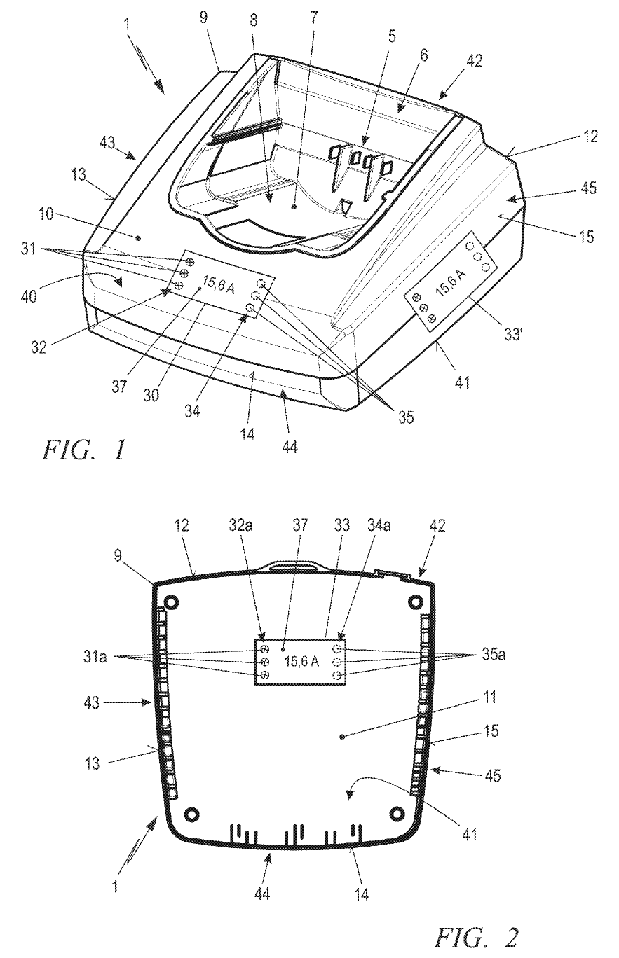

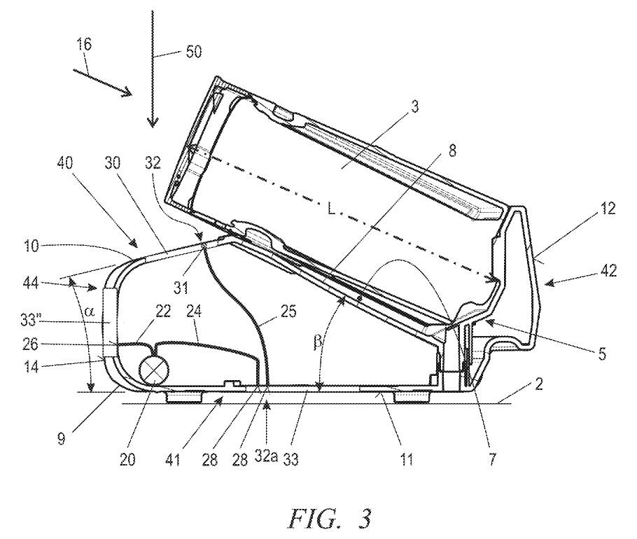

The charging device 1 represented in FIG. 1 for charging a battery pack 3 (FIG. 3) has a device housing 9. The device housing 9 has a front wall 10, a bottom wall 11 and side walls 12, 13, 14 and 15 that connect the front wall 10 to the bottom wall 11. The device housing 9 therefore has a plurality of housing sides 40, 41, 42, 43, 44 and 45. In the embodiment shown, the front wall 10 lies on a first housing side 40. The bottom wall 11 preferably lies on a second housing side 41 (FIG. 2). It may be advantageous for one of the side walls 12, 13, 14, 15 to lie on one of the second housing sides 42, 43, 44 or 45 of the device housing 9.

The charging device 1 has a first interface 30 for operating the charging device 1. The first interface 30 may in addition be configured for the operation display. As shown by FIGS. 1 and 3, the first interface 30 and a charging terminal 5 lie on a common housing side 40 of the charging device 1. The front wall 10 of the device housing 9 also lies on this first housing side 40.

The first interface 30 is configured in the embodiment as a combined display unit 32 and operating unit 34. The display unit 32 consists essentially of optical components 31, which may be configured by way of example as LEDs, light bulbs, light guides or similar lighting means. The operating unit 34 may include operating elements 35, which may be configured as buttons, touch sensors or the like.

In the embodiment shown, the combined display unit 32 and operating unit 34 is embodied as a display screen unit 37. The display screen unit 37 is in particular configured as a touchscreen. The advantage of a display screen unit 37 resides in the fact that variable operating parameters relating to the charging process and/or the attached battery pack 3 may also be displayed. The drawing shows by way of example a charging current of 15.6 A.

As shown by FIG. 1, the charging terminal 5 lies in a housing recess 7 which is formed in the front wall 10 on the first housing side 40. In order to charge a battery pack 3, it is placed into the housing recess 7 and pushed onto the charging terminal 5 so that electrical contacting of the battery pack 3 is established with charging electronics (not represented in detail) in the device housing 9 of the charging device 1.

The charging terminal 5 lies on a front face 6 of the housing recess 7. The housing recess 7 has a longitudinal wall 8. The longitudinal wall 8 delimits the housing recess 7 parallel to an insertion direction 16 of the battery pack 3, and the front face 6 delimits the housing recess 7 transversely with respect to the insertion direction 16. In the housing recess 7, the battery pack can be pushed onto the charging terminal 5 in the insertion direction 16.

The first interface 30 can preferably be fitted in the front wall 10 of the device housing 9 on the first housing side 40. The user can therefore on the one hand look at and on the other hand operate the depicted combined display unit 32 and operating unit 34 on the first housing side 40. In an alternative embodiment, the first interface 30 may be formed by an operating unit 34 and not have a display unit 32.

As shown by FIG. 3, a battery pack 3 with a large volume may protrude from the housing recess 7 because of its overall length L, so that on the one hand visibility of the display unit 32 in the viewing direction 50 onto the first housing side 40 is impeded or blocked. The battery pack 3 protruding from the housing recess 7 also makes manual access to the operating unit 34 difficult or impossible.

The longitudinal wall 8 of the housing recess 7 extends particularly in the direction of the greatest extent of the battery pack 3.

According to the disclosure, a second interface 33 is provided, which is arranged on one of the second housing sides 41, 42, 43, 44 or 45. As shown by FIG. 2, the second housing side 41 may be the bottom wall 11 of the device housing 9. The second interface 33 is held on or in this bottom wall 11, the second interface 33 preferably being fitted in the bottom wall 11.

The second interface 33 has a second display unit 32a with optical components 31a, which may be configured by way of example as LEDs, light bulbs or similar lighting means. The second interface 33 has a second operating unit 34a with operating elements 35a, which may again be configured as buttons, touch sensors or the like. In an alternative configuration, the second interface 33 may have a second operating unit 34a but no display unit 32a.

The second interface 33 is configured at least partially in the same way as the first interface 30. Preferably, the first interface 30 and the second interface 33 are configured in the same way, in particular configured identically. This reduces the number of different modules for assembling a charging device 1.

The optical display units 32 and 32a may be driven by a common light source 20 inside the device housing 9, as is schematically represented in FIG. 3. For instance, the display units 32 and 32a may be formed by the front faces 26, 28 of light guides 22, 24 that are supplied by the common light source 20. It may also be advantageous to copy the display unit 32 of the first interface 30 via an optical light guide 25 onto the display unit 32a of the second interface 33. The optical display unit 32 of the first interface 30 is forwarded onto the optical display unit 32a of the second interface 33.

One of the second housing sides, on which a second interface 33’ is arranged, may also be formed by one of the side walls 12, 13, 14 or 15. In FIG. 1, a second interface 33’ is provided on the housing side 45 which is formed by the second side wall 15 of the device housing 9. In FIG. 3, a second interface 33’’ is provided on the housing side 44 which is formed by the side wall 14.

It may be expedient to provide the charging device 1 with more than two interfaces, at least one further interface being arranged on a housing side 42, 43, 44 or 45.

The front wall 10 makes in particular an angle α with the bottom wall 11 which is from 0° to 85°, in particular from 0° to 60°. In particular, the angle α between the front wall 10 and the bottom wall 11 is less than 45°, in particular less than 30°. If the charging device 1 is stood on a plane horizontal support surface 2 so that the bottom wall 11 faces toward the support surface 2, the front wall 10 is oriented in particular upward.

The bottom wall 11 makes in particular an angle β with a longitudinal wall 8 of the housing recess 7 which is from 10° to 80°, in particular from 20° to 70°. The angle β is in particular selected so that an operator can see and access the second interface 33 when the charging device 1 is placed onto a battery pack 3. In this case, the longitudinal wall 8 extends in particular vertically.

It is understood that the foregoing description is that of the preferred embodiments of the invention and that various changes and modifications may be made thereto without departing from the spirit and scope of the invention as defined in the appended claims.

1. A charging device for charging a battery pack, the charging device comprising:
a device housing having a first housing side and a second housing side;
a first interface for operating the charging device;
a charging terminal for connecting the battery pack to the charging device;
said charging terminal and said first interface being arranged on said first housing side; a second interface for operating the charging device; and,
said second interface being arranged on said second housing side of said device housing.

2. The charging device of claim 1, wherein said first interface has a first display unit.

3. The charging device of claim 2, wherein said second interface has a second display unit.

4. The charging device of claim 1, wherein at least one of said first interface and said second interface has a display unit, said display unit being optically connected via light guides to a light source arranged in said device housing.

5. The charging device of claim 3, wherein a visual display of said first display unit of said first interface is copied via a light guide onto a visual display of said second display unit of said second interface.

6. The charging device of claim 1, wherein said first interface is configured as an operating unit.

7. The charging device of claim 1, wherein said second interface is configured as an operating unit.

8. The charging device of claim 1, wherein said first interface is as a display screen unit.

9. The charging device of claim 8, wherein said display screen unit is a touchscreen.

10. The charging device of claim 1, wherein said second interface is a display screen unit.

11. The charging device as claimed in claim 10, wherein said display screen unit is a touchscreen.

12. The charging device of claim 1, wherein said device housing has a front wall, a bottom wall, and a plurality of side walls that connect said front wall to said bottom wall, said front wall lying on said first housing side.

13. The charging device of claim 12, wherein said bottom wall lies on said second housing side.

14. The charging device of claim 12, wherein said front wall defines an angle (α) with said bottom wall which lies in a range from 0° to 85°.

15. The charging device of claim 13, wherein said front wall defines an angle (α) with said bottom wall which lies in a range from 0° to 85°.

16. The charging device of claim 1 further comprising at least one third interface for operating the charging device; and, said at least one third interface is arranged on a third housing side of said device housing.

17. The charging device of claim 16, wherein said device housing has a front wall, a bottom wall, and a plurality of side walls that connect said front wall to said bottom wall, said front wall lying on said first housing side; and, said third housing side is one of said plurality of side walls of said device housing.
